(19) United States
(12) Patent Application Publication
(10) Pub. No.: US 2007/0295732 A1
(43) Pub. Date: Dec. 27, 2007

(54) Gas Container With Viewing Window

(75) Inventors: Clemens Albert, Goldbach (DE); Markus Hornbach, Hammersbach (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/666,448

(22) PCT Filed: Sep. 26, 2005
(86) PCT No.: PCT/EP05/54831

§ 371 Date: Apr. 26, 2007

(30) Foreign Application Priority Data
Oct. 28, 2004 (DE) 10 2004 053 115.3

(51) Int. Cl. F17C 1/14

(52) U.S. Cl. 220/581

(57) ABSTRACT

A gas tank for receiving a protective gas in electrical switchgear of a power supply has a non-transparent housing section and a viewing window which occludes a passage in the non-transparent housing section in a gas-tight manner. The object is to provide an inexpensive gas tank that reliably seals even at higher temperatures. For this purpose, the viewing window is formed onto the non-transparent housing section.

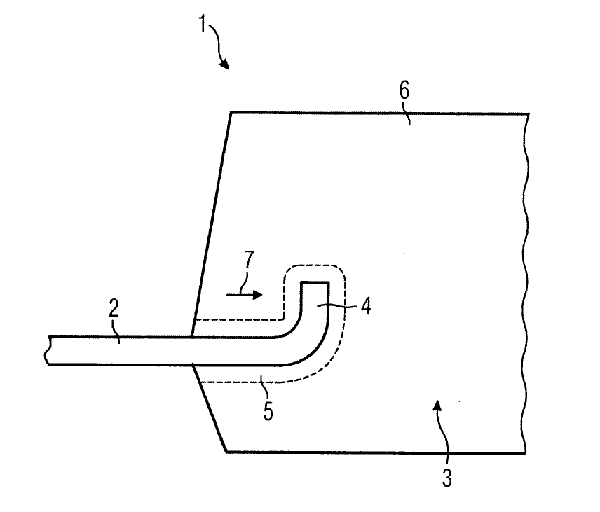

The invention relates to a gas container for receiving a protective gas in electrical power distribution switchgear, comprising a non-transparent housing section and a viewing window, which occludes a passage in the non-transparent housing section in a gas-tight manner.

The invention also relates to a method of producing a viewing window in a gas container.

Generic gas containers and methods are known from the common prior art. To allow the internals of closed, non-transparent containers to be viewed or optically monitored, gas containers generally have viewing windows, which consist of a commercially available glass, such as quartz glass, or of plastic. In order to avoid leaking of the gas containers, viewing windows are pressed together with the non-transparent housing section using a seal. It is possible here for example to form on the gas container a connecting sleeve which has a flange at its free end. The sealing means is placed onto the flange and the viewing window is finally pressed against the sealing means, the flange serving as an abutment.

As a departure from this, it is known in particular from high-pressure applications to heat a housing section, for example made of metal, which has a passage and, after inserting a viewing window into the passage, to allow the housing section to shrink onto the viewing window. The cooling down allows the metallic material to contract, thereby constricting the passage, so that the viewing window is pressed firmly in the passage. It must be ensured here that shattering of the viewing window is avoided. This is made possible by exact adaptation of the passage to the dimensioning of the viewing window of a complementary shape, while allowing for the coefficient of thermal expansion of these materials. However, a disadvantage of shrink-fitting a housing section onto a viewing window is that a firm fit of a viewing window is only made possible within narrow temperature ranges. Excessive cooling down of the metallic housing section could lead to breakage of the viewing window, whereas excessive heating of the gas container could cause the passage to expand, and consequently the viewing window to fall out.

The object of the invention is therefore to provide a gas container and a method of the type mentioned at the beginning that are inexpensive, providing a gas container that is reliably sealed even under relatively great temperature fluctuations.

The invention achieves this object on the basis of the generic device by the viewing window being molded onto the non-transparent housing section.

The invention achieves this object on the basis of the method mentioned at the beginning by a method of producing a viewing window in a gas container in which a passage is introduced into a non-transparent housing section and the viewing window is subsequently molded onto the rim of the passage, so that the viewing window occludes the passage in a gas-tight manner.

According to the invention, the viewing window is not pressed together with the housing section by means of a seal, and nor is the housing section shrink-fitted onto the viewing window. Rather, the viewing window is molded directly onto the rim of the passage. This molding attachment is performed for example by the injection-molding process, which is known per se. The viewing window advantageously consists of a plastic. As a departure from this, however, the use of viewing windows made of glass, such as quartz glass or the like, is also possible within the scope of the invention. Embrittlement of pressed sealing materials is avoided by the invention. The molding attachment provides a seal of adequate integrity of the viewing window even under relatively great temperature fluctuations.

The sealing attachment of the viewing window to the housing section makes the resultant composite even more insensitive to pressure fluctuations. This has an advantageous effect in particular in subsequent welding of this unit, since this could then entail distortions of the materials. Such distortions can be compensated better by the viewing window fitted according to the invention.

The housing section is, for example, a tubular housing section of a pressure vessel. As a departure from this, the housing section is a metal sheet with a rectangular contour. After molding attachment of the viewing window, the housing section fitted out in this way is welded together with further housing sections to form a pressure- and gas-resistant gas container. The gas container serves for example for receiving medium-voltage circuit-breakers and disconnectors.

An elastic adhesion promoter is advantageously arranged between the housing section and the viewing window. The adhesion promoter increases the integrity of the seal and the compressive deformability of the gas container according to the invention, in that an outstanding bonding effect is produced both with respect to the viewing window and with respect to the non-transparent housing section. In addition, the elasticity of the adhesion promoter provides compensation for different coefficients of expansion between the viewing window and the housing section, which is advantageous in particular under high temperature fluctuations. Finally, the adhesion promoter helps the viewing window to compensate for distortions that may occur during welding.

In a preferred further development of the invention, the passage is delimited by a rim with an edging. The edging is characterized by a section in the form of a ring or collar which protrudes at an angle from the housing section. This collar section increases the surface area of the rim region of the passage on which the viewing window can produce an adhesive effect. This increase in the surface area of attachment finally also has the effect of providing increased integrity of the seal of the switchgear container. Edging is advantageous in particular in combination with an elastic adhesion promoter.

A round passage is expediently provided. When the viewing window cools down after the molding attachment process, the material of the viewing window contracts concentrically to a common central point. With the round configuration of the passage, largely homogeneous forces of circumferentially equal magnitude consequently occur in the region of the rim. On account of this homogeneous force effect, disadvantageous shearing forces on the viewing window are avoided.

The viewing window is expediently configured in a curved manner, so that a lens effect is provided. According to this further development, the curved form of the viewing window makes it possible to obtain a magnified image of an inner closed gas container. A viewer looking through the viewing window into the interior of the gas container can consequently detect even minor changes and initiate any measures that may be required. It is also possible to use the viewing window to obtain a reduced image, so that as large a space as possible can be monitored from the outside.

In an advantageous further development of the method, the rim of the passage is provided with an elastic adhesion promoter before the molding attachment of the viewing window. As already stated, the adhesion promoter increases the elasticity, and consequently the temperature and pressure resistance, of the gas container.

In another expedient further development of the method according to the invention, the rim of the passage is edged. In this way, the surface area of attachment of the viewing window is increased.

Finally, it is also possible by the method according to the invention to mold the viewing window onto the rim of the passage with a curvature. It goes without saying that the curvature may be concavely or convexly formed, to make it possible to obtain an optical image that meets the respective requirements, that is to say a magnification or reduction.

Other expedient refinements and advantages of the invention are the subject of the following description of exemplary embodiments of the invention with reference to the FIGURE of the drawing, in which the

FIGURE shows an exemplary embodiment of the invention in a partial cross-sectional view.

In the single FIGURE, an exemplary embodiment of the gas container 1 according to the invention is represented in a sectional view. The gas container 1 shown has an opaque or non-transparent housing section 2, in which a passage 3 is provided. The passage 3 is formed in a circular-symmetrical manner, that is to say round, so that only a portion of the passage 3 is shown in the FIGURE for reasons of clarity.

It can be seen that the rim of the housing section 2 has an edging 4, which is arranged at right angles to the remaining part of the housing section 2. Arranged on the edging 4, or in other words on the freely bent rim of the passage 3, is an elastic adhesion promoter 5, part of which is indicated in the FIGURE by a dashed line. Molded onto the adhesion promoter 5 is a viewing window 6, which consists of a transparent material, here a plastic, such as for example a solid resin.

The plastic of the viewing window 6 has been applied to the rim of the passage 3 by the injection-molding process, the plastic contracting after curing. This contraction has the effect of producing forces in the direction shown by the arrow 7 that act on the edging 4. These forces are compensated to the greatest extent by the elastic adhesion promoter 5, whereby improved sealing of the viewing window 6 on the housing section 2 is obtained. The housing section 2 consists for example of a customary metal sheet and, after fitting of the viewing window 6, is welded in a gas-tight manner to the remaining sections of the gas container, so that a circumferentially closed and gas-tight gas container is provided.

1-9. (canceled)

10. A gas container for receiving a protective gas in electrical power distribution switchgear, comprising:
a housing having a non-transparent housing section;
a passage formed in said non-transparent housing section; and
a viewing window formed onto said non-transparent housing section and closing off said passage in said non-transparent housing section in a gas-tight manner.

11. The gas container according to claim 10, wherein an elastic adhesion promoter is disposed between the non-transparent housing section and the viewing window.

12. The gas container according to claim 10, which comprises a rim with an edging delimiting said passage in said non-transparent housing section.

13. The gas container according to claim 10, wherein said passage in said non-transparent housing section is a round passage.

14. The gas container according to claim 10, wherein said viewing window has a curved contour, forming a lens effect.

15. A method of producing a gas container, which comprises:
forming a passage with a rim into a non-transparent housing section of the gas container; and
subsequently molding a viewing window onto the rim of the passage in the non-transparent housing section to thereby close off the passage in a gas-tight manner.

16. The method according to claim 15, which comprises coating the rim of the passage with an elastic adhesion promoter prior to attaching and molding the viewing window.

17. The method according to claim 15, which comprises edging the rim of the passage prior to attaching and molding the viewing window.

18. The method according to claim 15, which comprises molding the viewing window with a curvature onto the rim of the passage.
